(19) United States
(12) Patent Application Publication
(10) Pub. No.: US 2023/0086437 A1
(43) Pub. Date: Mar. 23, 2023

(54) NAME RESOLUTION RESULT CONTROL SYSTEM, NAME RESOLUTION RESULT CONTROL METHOD AND PROGRAM

(71) Applicant: Nippon Telegraph and Telephone Corporation, Tokyo (JP)

(72) Inventors: Kotaro ONO, Musashino-shi, Tokyo (JP); Yuki NAKAHARA, Musashino-shi, Tokyo (JP); Ryota ISHIBASHI, Musashino-shi, Tokyo (JP); Takeshi KUWAHARA, Musashino-shi, Tokyo (JP)

(21) Appl. No.: 17/802,211

(22) PCT Filed: Feb. 28, 2020
(86) PCT No.: PCT/JP2020/008533

§ 371 Date: Aug. 25, 2022

(51) Int. Cl. H04L 61/4511; H04L 67/10

(52) U.S. Cl. CPC H04L 61/4511; H04L 67/10

(57) ABSTRACT

A name resolution result control system which controls a name resolution result at a terminal which utilizes an application on one or more edge platforms which are physically deployed in a dispersed manner includes a name resolution unit configured to receive a request for name resolution for the application from the terminal and transmit information of the application on an edge platform which is optimal for the terminal to the terminal as a name resolution result, and a name resolution result control unit configured to execute control for deleting the name resolution result at the terminal by being triggered by a predetermined event.

### TECHNICAL FIELD

The present invention relates to a technique of resolving the name of an application which runs on a server platform in a system having a configuration where a terminal is connected to the server platform deployed at a position physically close to the terminal via a network.

### BACKGROUND ART

Edge computing in which servers which process information are deployed near the terminals on a network (NW) between a cloud server and the terminals has been proposed (Non-Patent Literature 1). In edge computing, server platforms (edge platforms) which are physically deployed in a dispersed manner enable dispersion and sophistication of various functions and processing which have been implemented on a cloud server side or on a terminal side in related art. In accordance with this, efforts are being made to support services in new fields such as services which require aggregation of a large volume of information and high-speed processing as well as services which require low latency.

Utilization of an application (app) running on an edge platform by a terminal requires name resolution to secure connection with the app. Concerning name resolution of the app on the edge platform, a basic function of a management function of the edge platform creating a name resolution result on the basis of rules, requirements, or the like, required by the app and making a response of the created name resolution result in a case where name resolution is requested by a terminal is under review as standard specifications (Non-Patent Literature 2).

Meanwhile, one of the techniques of making a response of name resolution results different in accordance with IP addresses of request sources in response to requests for name resolution from terminals includes GeoDNS (Non-Patent Literature 3). In GeoDNS, responses of IP addresses different in accordance with IP addresses of inquiry sources can be made in response to inquiries for the same name to a domain name service (DNS) server by transmitting IP address subnet information, or the like, of inquiry sources to DNS of an inquiry destination.

If a position of an inquiry source terminal can be narrowed down by an IP address band, a response of a name resolution result can be controlled so as to enable utilization of an app which is optimal (for example, physically close) for the inquiry source terminal.

### CITATION LIST

### Non-Patent Literature

Non-Patent Literature 1: MEC in 5G networks, ETSI White Paper No. 28, June 2018.

Non-Patent Literature 2: Mobile Edge Computing (MEC); Framework and Reference Architecture, ETSI GS MEC 003 V1.1.1, 2016 March.

Non-Patent Literature 3: Client Subnet in DNS Queries, IETF RFC 7871, 2016.

### SUMMARY OF THE INVENTION

### Technical Problem

It is assumed in services to be provided on edge platforms which are physically deployed in a dispersed manner that apps are respectively provided in a plurality of areas. In such an environment, in a case where a terminal which moves across a plurality of areas utilizes the service, the terminal is preferably connected to the app on an edge platform which is optimal on a moment-to-moment basis.

However, in related art, there is a problem in that in a case where an optimal edge platform changes as a result of the terminal moving across areas, a case may occur where the terminal cannot be connected to the app on the edge platform which is optimal at that moment.

The present invention has been made in view of the above-described point and is directed to providing a technique of enabling a terminal which utilizes a service to be provided on edge platforms which are physically deployed in a dispersed manner, to be connected to an app on an edge platform which is optimal for the terminal even in a case where the terminal moves across areas.

### Means for Solving the Problem

According to a technique of disclosure, a name resolution result control system is provided, which controls a name resolution result at a terminal which utilizes an application on one or more edge platforms which are physically deployed in a dispersed manner, the name resolution result control system including

a name resolution unit configured to receive a request for name resolution for the application from the terminal and transmit information of the application on an edge platform which is optimal for the terminal to the terminal as a name resolution result, and

a name resolution result control unit configured to execute control for deleting the name resolution result at the terminal by being triggered by a predetermined event.

### Effects of the Invention

According to a technique of disclosure, a technique of enabling a terminal which utilizes a service to be provided on edge platforms which are physically deployed in a dispersed manner, to be connected to an app on an edge platform which is optimal for the terminal even in a case where the terminal moves across areas, is provided.

### BRIEF DESCRIPTION OF DRAWINGS

FIG. 1 is a view for explaining a service to be provided in a plurality of areas.

FIG. 2 is a view for explaining the service to be provided in the areas.

FIG. 3 is a view illustrating a functional configuration of a name resolution result control system in a first embodiment.

FIG. 4 is a sequence chart in a case where a terminal performs name resolution.

FIG. 5 is a flowchart illustrating operation of a name resolution result control unit in the first embodiment.

FIG. 6 is a view illustrating an example of an environment in a second embodiment.

FIG. 7 is a view illustrating a functional configuration of an edge management platform 100 in the second embodiment.

FIG. 8 is a flowchart illustrating operation of the name resolution result control unit in the second embodiment.

FIG. 9 is a view illustrating functional configurations of the edge management platform 100 and a terminal 200 in a third embodiment.

FIG. 10 is a flowchart illustrating operation of the name resolution result control unit on the terminal side in the third embodiment.

FIG. 11 is a flowchart illustrating operation of the name resolution result control unit on the edge management platform side in the third embodiment.

FIG. 12 is a view illustrating a hardware configuration example of a device.

### DESCRIPTION OF EMBODIMENTS

Embodiments of the present invention will be described below with reference to the drawings. The embodiments described below are merely an example, and embodiments to which the present invention is applied are not limited to the following embodiments.

(Outline of Embodiment)

In the present embodiment, a case will be assumed where applications (hereinafter, apps) for utilizing a service are respectively provided in a plurality of areas for the service to be provided on edge platforms which are physically deployed in a dispersed manner. A technique will be described which, in such an environment, enables a terminal which utilizes the service to be provided on edge platforms which are physically deployed in a dispersed manner, to be connected to an app on an edge platform which is optimal for the terminal even in a case where the terminal moves across areas, in the present embodiment.

The app on the edge platform which is optimal for the terminal, for example, includes, but is not limited to, an app on an edge platform which is the closest to the terminal. For example, in a case where delay requirements are not so severe, an app on an edge platform other than the app on the closest edge platform can be selected as the optimal app by a name resolution result control system, which will be described later. Further, there is a case where more importance is placed on capacity than closeness depending on service requirements, and an app on an edge platform having a large amount of available server resources and network resources is selected as the optimal app.

As will be described below, in the present embodiment, a terminal requests name resolution of an app to be connected every time the terminal is connected to networks in different areas, and the name resolution result control system makes a response of a name resolution result for connecting to an optical app in response to the request, so that the terminal can be connected to an optimal app on a moment-to-moment basis.

In the following description, “closest” is used as an example of “optimal”. However, as described above, “optimal” is not limited to “closest”.

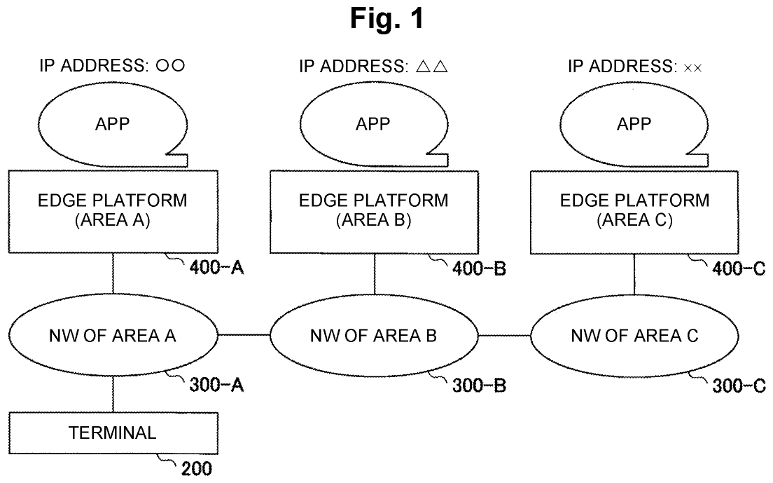

FIG. 1 illustrates an entire configuration example of the system in the present embodiment. In the example illustrated in FIG. 1, edge platforms 400-A to 400-C are provided in areas A to C, and apps are running on the respective edge platforms. Note that the edge platform may be referred to as an edge device.

In the example in FIG. 1, a terminal 200 is connected to a network (NW) of an area where the terminal 200 is located to utilize the app on the edge platform 400 in the area. FIG. 1 illustrates an example of a case where the terminal 200 is connected to a NW 300-A in the area A. While a wireless communication terminal such as a smartphone is assumed as the terminal 200 of the present embodiment, the terminal to which the present invention can be applied is not limited to a wireless communication terminal. For example, the present invention can also be applied to a case where a PC, or the like, which does not have a wireless function is carried to another location and used by being connected to a network.

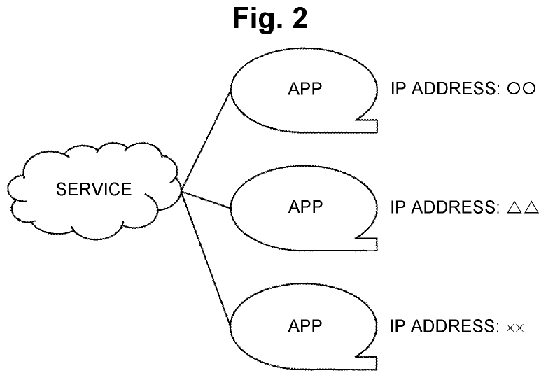

As illustrated in FIG. 2, the service of the present embodiment is constituted with the apps to which different IP addresses are allocated.

In FIG. 1, the terminal 200 moves across a plurality of areas, resolves the name of the service and utilizes the service. In this case, given service requirements, resource cost including a NW, and the like, the terminal 200 is preferably connected to an app on an edge platform which is the closest to the terminal 200 on a moment-to-moment basis. Note that “closest” may mean shortest in terms of a physical distance or may mean shortest in terms of a network distance (such as the number of hops and delay).

Specifically, in FIG. 1, in a case where the terminal 200 is located in the area A (connected to the NW 300-A in the area A), the terminal 200 utilizes the app (IP address: AA) on the edge platform 400-A in the area A. The terminal 200 therefore requires to request name resolution of an app to be connected and receive a response of an appropriate name resolution result to the request for the name resolution.

For example, the technique disclosed in Non-Patent Literature 3 can be used to achieve this. In this technique, a response of a name resolution result in which a geographical terminal position is taken into account can be made by storing information regarding the terminal 200 in a database and making a response to the name resolution result on the basis of the information.

However, even in a case where the closest edge platform changes as a result of the terminal 200 moving across areas, a cache of the name resolution result remains in the terminal 200. Thus, the terminal 200 cannot be connected to the app on the edge platform which is the closest at that moment.

It is also possible to take a measure of setting 0 at time to live (TTL) of the cache of a name resolution result so as to prevent the cache of the name resolution result from remaining. However, in this case, a request for name resolution occurs every time the terminal 200 tries to utilize the service. This increases load to be applied to resources such as a DNS server and a NW which are to be used for making a response to a request for name resolution due to requests for name resolution and responses to the requests, which are originally unnecessary.

The present embodiment enables the terminal 200 to request name resolution only in a case where it is truly necessary, with a mechanism, which will be described in the following embodiments. It is therefore possible to avoid nonoccurrence of a request for name resolution when it is necessary to request name resolution and avoid occurrence of an unnecessary request for name resolution.

First to seventh embodiments will be described below. In all of the first to the seventh embodiments, the environment as illustrated in FIG. 1 and FIG. 2 will be assumed where apps for providing services are mounted on edge platforms which are physically deployed in a dispersed manner, and the terminal 200 utilizes an app via a NW (for example, a local NW such as an access network).

### First Embodiment

First, the first embodiment will be described. In the first embodiment, a name resolution result control system 100 manages apps on the edge platforms 400 which are physically deployed in a dispersed manner and a status of NW connection of the terminal 200 and controls a response of a name resolution result associated with NW information and occurrence of a request for name resolution on the terminal 200 side. Note that the “name resolution result control system” may be referred to as a “name resolution result control device”. Further, in the first embodiment, the name resolution result control system 100 may be provided anywhere if the name resolution result control system 100 can perform information collection and control, which will be described later. For example, the name resolution result control system 100 may be provided in an edge platform or in a terminal.

In the first embodiment, when the terminal 200 utilizes a service to be provided on the edge platform 400, the terminal 200 requests name resolution to the name resolution result control system 100. Note that it is assumed that the app which runs on the edge platform 400 is aimed at a user of the service which is provided on the edge platform 400 and is not released on the Internet side.

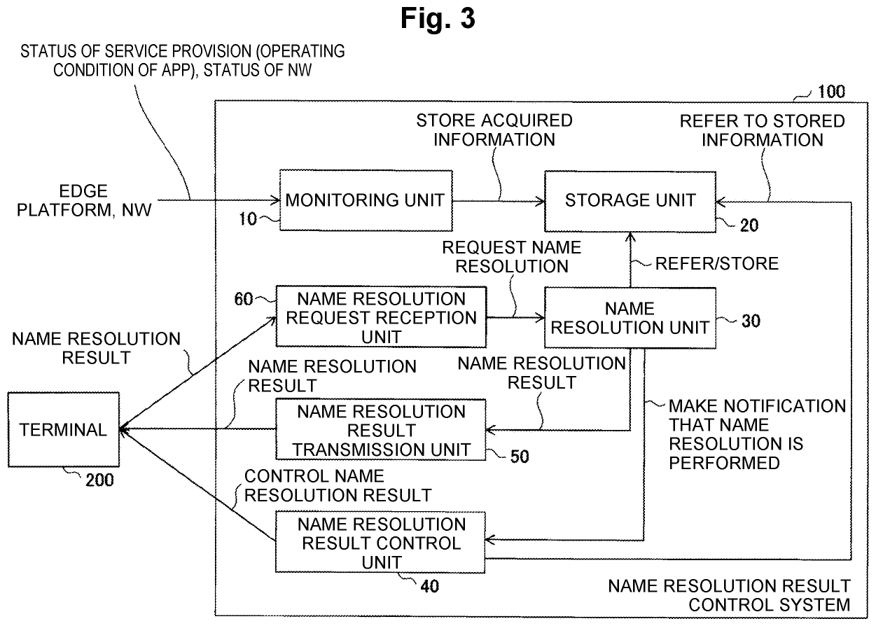

FIG. 3 illustrates an example of a functional configuration of the name resolution result control system 100 in the first embodiment. As illustrated in FIG. 3, the name resolution result control system 100 of the first embodiment includes a monitoring unit 10, a storage unit 20, a name resolution unit 30, a name resolution result control unit 40, a name resolution result transmission unit 50 and a name resolution request reception unit 60.

<Sequence of Entire System>

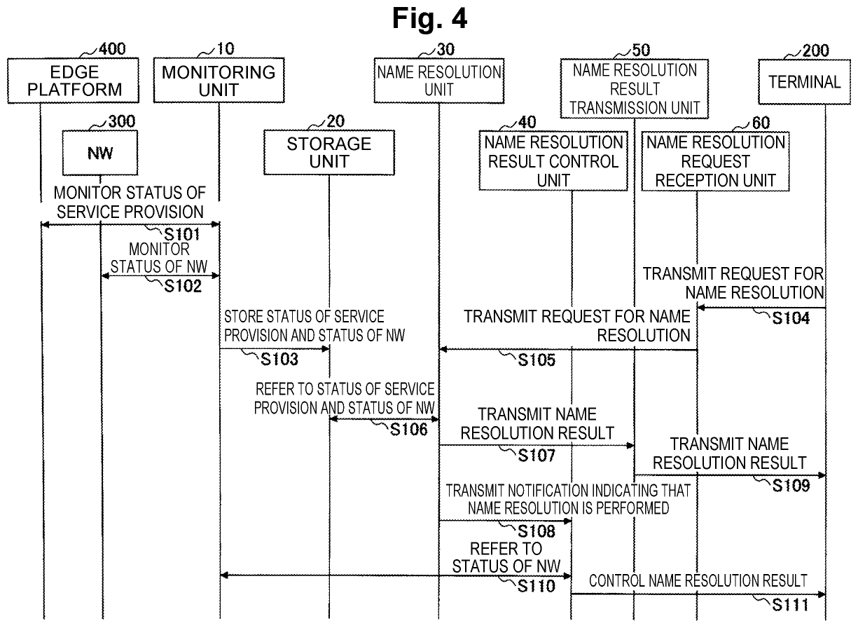

FIG. 4 is a sequence chart indicating the following two points. First, the terminal 200 requests name resolution and receives a name resolution result, and the name resolution result control system 100 starts continuous monitoring of a status of NW connection of the terminal 200 by being triggered by name resolution in response to the request for name resolution by the terminal 200. Then, when the terminal 200 moves across areas and an edge platform which is the closest to the terminal 200 changes, for example, the name resolution result control system 100 controls a name resolution result held on the terminal 200 side as necessary.

An operation example of the name resolution result control system 100 having the configuration illustrated in FIG. 3 will be described with reference to the flowchart in FIG. 4.

In S101, the monitoring unit 10 monitors and collects a status of service provision on the edge platform 400, and in S102, the terminal 200 monitors and collects a status of the NW 300 to which the terminal 200 is to be connected. In S103, the monitoring unit 10 stores the status of service provision on the edge platform 400 and the status of the NW 300 to which the terminal 200 is to be connected in the storage unit 20.

More specifically, the information to be collected and stored described above is information necessary for making a response of an appropriate name resolution result when a request for name resolution of an app which runs on the edge platform 400 occurs. For example, the information includes an operating condition (such as which app is running) on the edge platforms 400 which are physically deployed in a dispersed manner, an IP address of the app, a NW to which the terminal 200 is connected, and the like.

The name resolution request reception unit 60 receives a request for name resolution of the app on the edge platform 400 transmitted by the terminal 200 in S104 and transmits the request for name resolution to the name resolution unit 30 in S105.

The name resolution unit 30 determines information (specifically, an IP address) of the app which should be provided as a response to the terminal 200, the NW 300 to which the terminal 200 is currently connected, the closest edge platform in a case where the terminal 200 is connected to the NW 300 among edge platforms on which the app for which name resolution is requested runs, or the like. Here, to determine these, the name resolution unit 30 refers to information which is stored in the storage unit 20, and which is necessary for making a response of an appropriate name resolution result upon occurrence of a request for name resolution of an app which runs on the edge platform 400 (S106).

In S107, the name resolution unit 30 creates a name resolution result on the basis of the determination and transmits the name resolution result (an IP address of the app relating to the inquiry) to the name resolution result transmission unit 50.

Further, the name resolution unit 30 stores the name resolution result and a condition upon the name resolution (information indicating which terminal 200 is connected to which NW 300 when the name resolution result is performed) together in the storage unit 20. Further, the name resolution unit 30 transmits a notification indicating that a name resolution response is made to the request for name resolution from the terminal 200, to the name resolution result control unit 40 (S108).

In S109, the name resolution result transmission unit 50 transmits the name resolution result received from the name resolution unit 30 to the terminal 200.

The name resolution result control unit 40 starts continuous monitoring of a status of NW connection of the terminal 200, which is to be stored in the storage unit 20 via the monitoring unit 30 in S110 by being triggered by the notification from the name resolution unit 30. The name resolution result control unit 40 controls the name resolution result at the terminal 200 in S111 on the basis of the status of NW connection of the terminal 200.

<Operation of Name Resolution Result Control Unit 40>

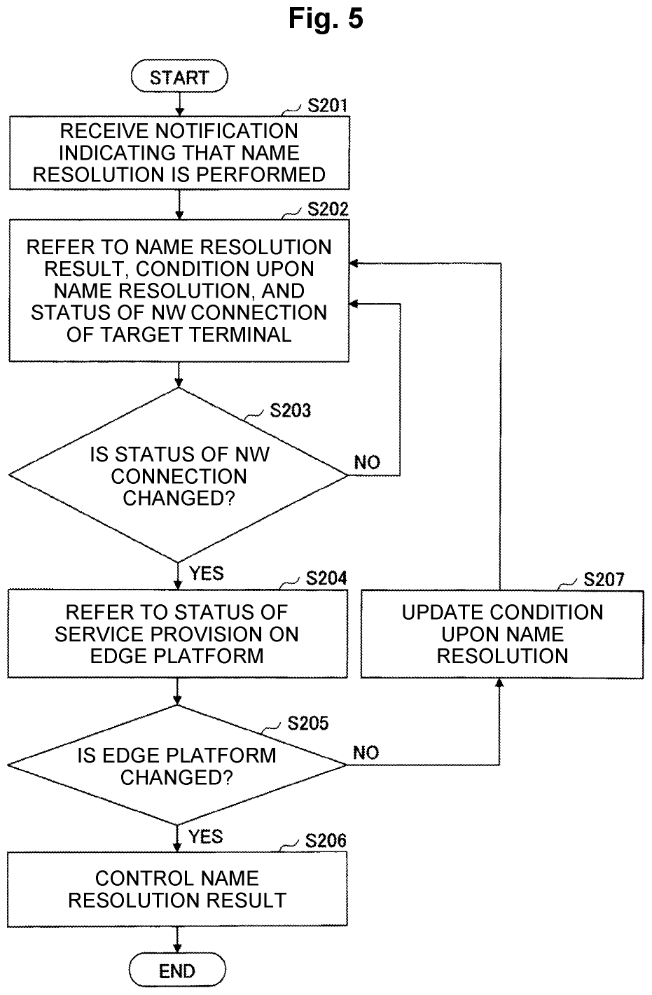

FIG. 5 is a flowchart illustrating operation of the name resolution result control unit 40. The operation of the name resolution result control unit 40 will be described in detail along procedure in FIG. 5.

In S201, the name resolution result control unit 40 receives the notification indicating that name resolution is performed from the name resolution unit 30.

In S202, the name resolution result control unit 40 refers to the name resolution result and the condition upon name resolution stored in the storage unit 20, and the status of NW connection of the terminal 200 for which the name resolution is performed.

In S203, the name resolution result control unit 40 determines whether or not the NW to which the terminal 200 is to be connected changes. In a case where a determination result in S203 is No, the processing returns to S202. In a case where the determination result in S203 is Yes, the processing proceeds to S204.

In S204, the name resolution result control unit 40 refers to a status of service provision (such as an app which is running) on each edge platform 400 stored in the storage unit 20.

In S205, the name resolution result control unit 40 determines whether or not an edge platform which is the closest to the terminal 200 among one or more edge platforms 400 on which the app for which name resolution is requested by the terminal 200 is running, changes. In a case where a determination result in S205 is Yes, the processing proceeds to S206, and in a case where the determination result is No, the processing proceeds to S207.

In S207, the name resolution result control unit 40 controls (deletes or the like) the name resolution result stored on the terminal 200 side. Note that in the first embodiment, the name resolution result stored on the terminal 200 side may be deleted on the basis of the control using any method.

In S207, in the case described next, the name resolution result control unit 40 updates the condition upon name resolution stored in the storage unit 20 on the basis of the status of NW connection of the terminal 200 at that moment and continuously monitors the status of NW connection of the terminal 200. Here, the above-described case refers to a case where while the NW to which the terminal 200 is to be connected changes, an edge platform which is the closest to the terminal 200 among one or more edge platforms on which the app for which name resolution is requested by the terminal 200 is running, does not change.

The above-described updating is performed regarding a “NW to which the terminal is connected” among information regarding a terminal which performs the name resolution result and a NW to which the terminal is connected upon the name resolution result. In other words, here, the NW to which the terminal 200 is to be connected is updated to the changed NW.

<Operation and Effects of First Embodiment>

In a case where the name resolution result stored on the terminal 200 side is deleted as a result of control in S206, if the terminal 200 tries to continuously utilize the service on the edge platform 400, the name resolution result does not exist on the terminal 200 side, and thus, the terminal 200 transmits a request for name resolution again at that moment.

Meanwhile, in a case where the edge platform which is the closest to the terminal 200 does not change (in a case where a determination result in S205 is No), the name resolution result is kept stored on the terminal 200 side, and thus, the terminal 200 can continuously utilize the service (can be connected to the app) using the name resolution result.

Thus, according to the first embodiment, an appropriate response of name resolution based on the NW to which the terminal 200 is to be connected (a response of information for connecting to the app on the edge platform which is the closest to the terminal) can be made, and further, a new request for name resolution can be made only in a case where the edge platform which is the closest to the terminal 200 changes and the terminal 200 tries to utilize the service. Thus, according to the first embodiment, it is possible to avoid a situation where load applied to resources such as a DNS server and a NW which are to be used for making a response to a request for name resolution increases due to requests for name resolution and responses to the requests, which are originally unnecessary.

Note that the above-described operation and effects can be basically similarly obtained in other embodiments.

### Second Embodiment

A second embodiment will be described next. In the second embodiment, the name resolution result stored on the terminal 200 side is deleted on the initiative of the edge platform 400 side.

In the second embodiment, when the terminal 200 utilizes a service to be provided on the edge platform 400, the terminal 200 requests name resolution to the name resolution result control system 100 (also referred to as the edge management platform). Note that it is assumed that the app which runs on the edge platform 400 is aimed at a user of the service which is to be provided on the edge platform 400 and is not released on the Internet side.

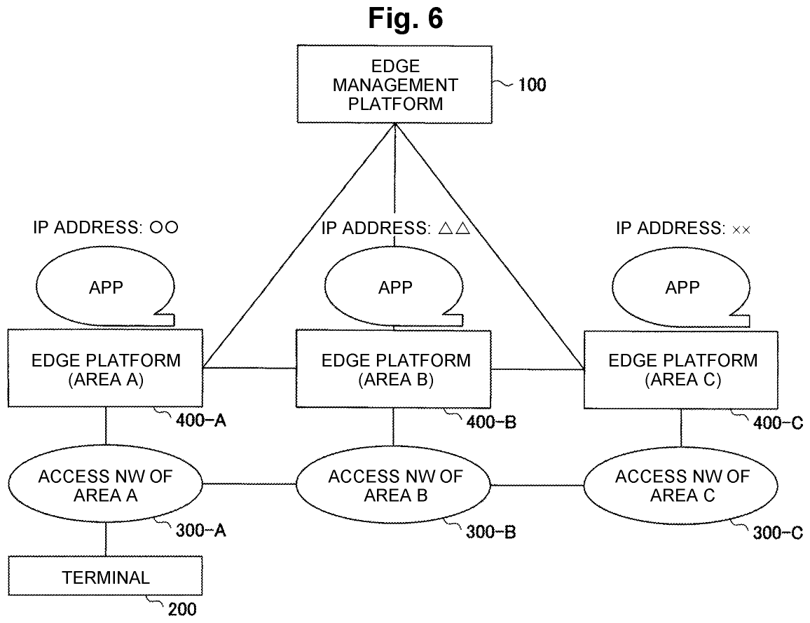

FIG. 6 illustrates an entire configuration diagram of the system in the second embodiment. As illustrated in FIG. 6, the name resolution result control system 100 as the edge management platform is connected to the edge platforms 400 in the system illustrated in FIG. 1 via a network. However, in the second embodiment, the terminal 200 utilizes the app on the edge platform 400 by being connected to a local access NW 300.

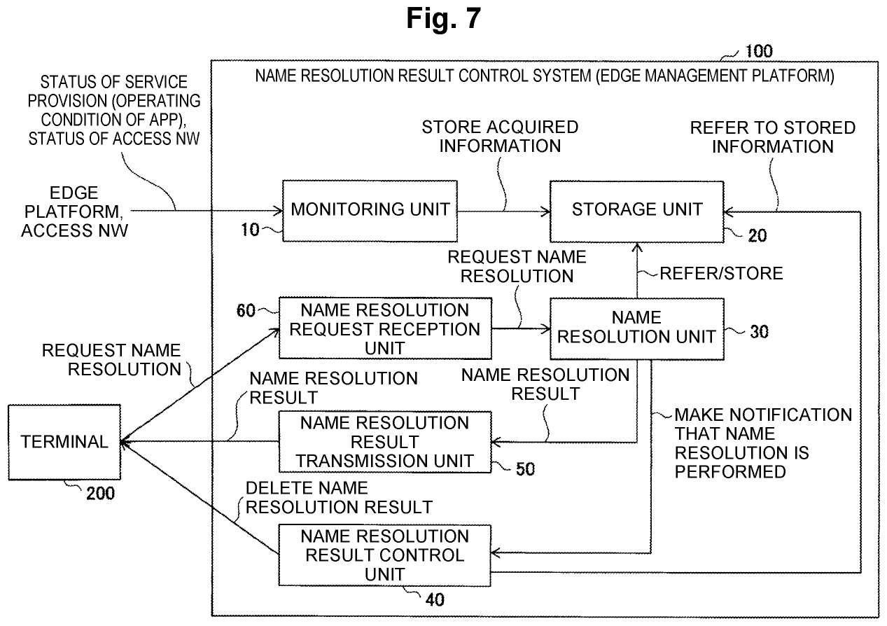

FIG. 7 illustrates an example of a functional configuration of the name resolution result control system 100 (edge management platform) in the second embodiment. As illustrated in FIG. 7, the name resolution result control system 100 in the second embodiment includes the monitoring unit 10, the storage unit 20, the name resolution unit 30, the name resolution result control unit 40, the name resolution result control unit 40, the name resolution result transmission unit 50 and the name resolution request reception unit 60 in a similar manner to the name resolution result control system in the first embodiment.

Operation of the name resolution result control system 100 (edge management platform) in the second embodiment is basically the same as the operation described with reference to FIG. 4 in the first embodiment.

In other words, the monitoring unit 10 monitors an operating condition of the apps on the edge platforms 400 which are physically deployed in a dispersed manner in respective areas and a status of connection of the terminal 200 to the access NW of each area and stores information acquired by monitoring in the storage unit 20. In other words, the monitoring unit 10 collects information (such as an operating condition of the apps on edge platforms which are physically deployed in a dispersed manner, the IP addresses of the apps and the access NW to which the terminal is connected) necessary for making a response of an appropriate name resolution result when name resolution of the app which runs on the edge platform is requested to create a database and updates the information as appropriate.

The terminal 200 requests name resolution to the name resolution result control system 100 (edge management platform) to utilize the service which is to be provided on the edge platform 400.

The name resolution request reception unit 60 receives a request for name resolution of the app on the edge platform 400 transmitted by the terminal 200 and transmits the request to the name resolution unit 30.

The name resolution unit 30 determines an access NW to which the terminal 200 is connected, the closest edge platform 400 in a case where the terminal 200 is connected to the access NW among one or more edge platforms 400 on which the app for which name resolution is requested runs, and thus, information of the app which should be provided as a response. To determine these, the name resolution unit 30 refers to information which is stored in the storage unit 20 and which is necessary for making a response of an appropriate name resolution result when name resolution of the app which runs on the edge platform is requested. Then, the name resolution unit 30 creates a name resolution result on the basis of the determination and transmits the name resolution result to the name resolution result transmission unit 50.

Further, the name resolution unit 30 stores the name resolution result and a condition upon the name resolution (information regarding a terminal which performs the name resolution result and an access NW to which the terminal is connected upon the name resolution result) together in the storage unit 20.

At the same time, the name resolution unit 30 transmits a notification indicating that a response of name resolution is made to the request for name resolution from the terminal 200 to the name resolution result control unit 40.

The name resolution result transmission unit 50 transmits the received name resolution result to the terminal 200. As a result of this, the terminal 200 starts connection to the app which runs on the edge platform 400 on the basis of the received name resolution result.

<Operation of Name Resolution Result Control Unit 40>

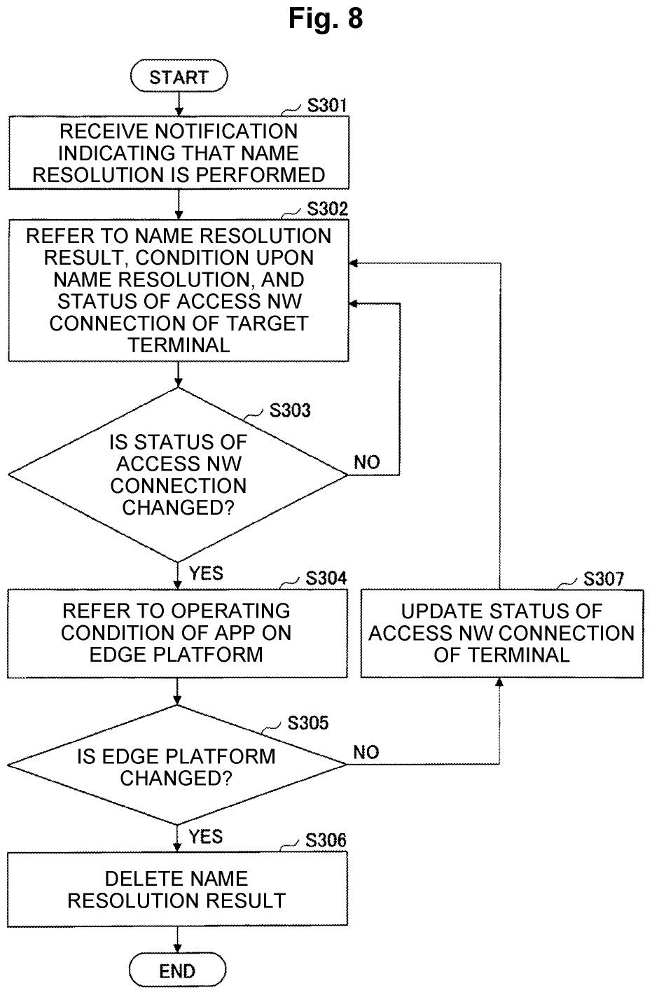

FIG. 8 is a flowchart illustrating operation of the name resolution result control unit 40 in the second embodiment. The operation of the name resolution result control unit 40 will be described in detail with reference to FIG. 8.

In S301, the name resolution result control unit 40 receives the notification indicating that name resolution is performed from the name resolution unit 30.

In S302, the name resolution result control unit 40 refers to the name resolution result and the condition upon the name resolution stored in the storage unit 20, and a status of access NW connection of the terminal 200 for which the name resolution is requested.

In S303, the name resolution result control unit 40 determines whether or not an access NW to which the terminal 200 is to be connected changes. In a case where a determination result in S303 is No, the processing returns to S302. In a case where the determination result in S303 is Yes, the processing proceeds to S304.

In S304, the name resolution result control unit 40 refers to the status of service provision (such as the app which is running) on each edge platform 400 stored in the storage unit 20.

In S305, the name resolution result control unit 40 determines whether or not the edge platform 400 which is the closest to the terminal 200 among one or more edge platforms on which the app for which name resolution is requested by the terminal 200 runs changes. In a case where a determination result in S305 is Yes, the processing proceeds to S306, and in a case where the determination result is No, the processing proceeds to S307.

In S306, that is, in a case where the access NW to which the terminal 200 is to be connected changes, and the edge platform which is the closest to the terminal 200 among one or more edge platforms on which the app for which name resolution is requested by the terminal 200 runs changes, the name resolution result control unit 40 deletes the name resolution result stored on the terminal 200 side.

A specific deleting method is not limited to a particular method. For example, the deleting methods include a method in which an app for a user of a service to be provided on the edge platform 400 is installed in the terminal 200 in advance, authority of operating the cache of the name resolution result of the terminal 200 is provided to the app, and the app clears or invalidates the cache of the name resolution result stored in the terminal 200 by way of API on the basis of an instruction from the name resolution result control unit 40.

In S307, in the case described next, the name resolution result control unit 40 updates the condition upon name resolution stored in the storage unit 20 on the basis of the status of access NW connection of the terminal 100 at that moment and continuously monitors the status of access NW connection of the terminal 200. Here, the case described above refers to a case where while the access NW to which the terminal 200 is to be connected changes, the edge platform 400 which is the closest to the terminal 200 among one or more edge platforms 400 on which the app for which name resolution is requested by the terminal 200 runs does not change.

### Third Embodiment

A third embodiment will be described next. In the third embodiment, the name resolution result stored on the terminal 200 side is deleted on the initiative of the terminal 200 side.

In the third embodiment, when the terminal 200 utilizes a service to be provided on the edge platform 400, the terminal 200 requests name resolution to the name resolution result control system 100 (edge management platform). Note that the app which runs on the edge platform 400 is aimed at a user of the service to be provided on the edge platform 400 and is not released on the Internet side. Further, the name resolution result control system 100 (edge management platform) includes API which provides a status of access NW connection of the terminal 200, and the terminal 200 itself can grasp the access NW to which the terminal 200 is connected by way of the API.

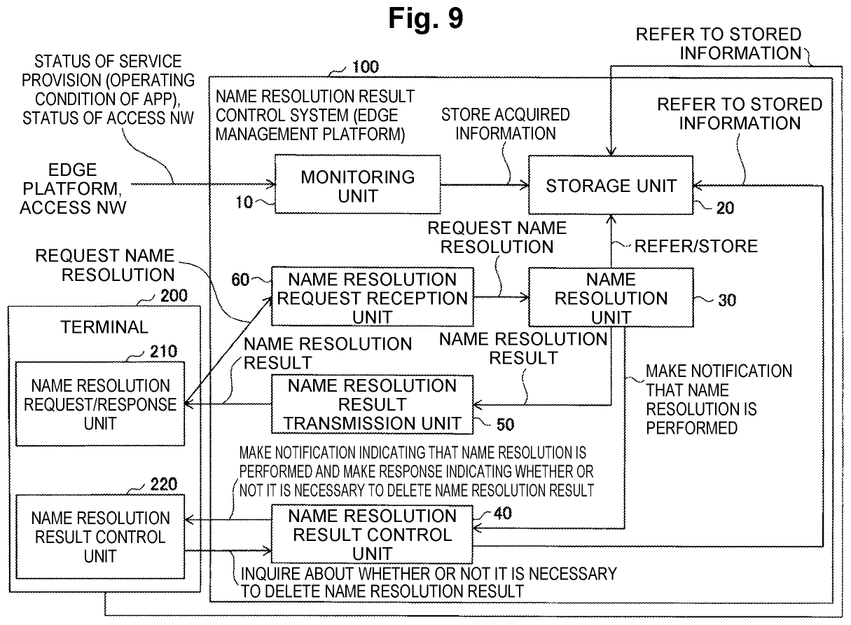

An entire configuration of the system in the third embodiment is similar to that in the second embodiment and is as illustrated in FIG. 6. FIG. 9 illustrates an example of a functional configuration of the name resolution result control system 100 (edge management platform) in the third embodiment. As illustrated in FIG. 9, the name resolution result control system 100 (edge management platform) of the third embodiment includes the monitoring unit 10, the storage unit 20, the name resolution unit 30, the name resolution result control unit 40 on the edge management platform side, the name resolution result control unit 40, the name resolution result transmission unit 50 and the name resolution request reception unit 60 in a similar manner to the name resolution result control system in the first embodiment.

As illustrated in FIG. 9, the terminal 200 in the third embodiment includes a name resolution request/response unit 210 and a name resolution result control unit 220 on the terminal 200 side.

Operation of the name resolution result control system 100 (edge management platform) in the third embodiment is basically the same as the operation described with reference to FIG. 4 in the first embodiment.

In other words, the monitoring unit 10 monitors an operating condition of the apps on the edge platforms 400 which are physically deployed in a dispersed manner in respective areas and a status of connection of the terminal 200 to an access network NW in each area and stores information acquired through monitoring in the storage unit 20. In other words, the monitoring unit 10 collects information (such as an operating condition of the apps on the edge platforms which are physically deployed in a dispersed manner, the IP addresses of the apps and the access NW to which the terminal is connected) necessary for making a response of an appropriate name resolution result when name resolution of the app which runs on the edge platform 400 is requested to create a database and updates the information as appropriate.

The name resolution request/response unit 210 of the terminal 200 requests name resolution to the name resolution result control system 100 (edge management platform) in order that the terminal 200 utilizes the service to be provided on the edge platform 400.

The name resolution request reception unit 60 receives a request for name resolution of the app on the edge platform 400 transmitted by the terminal 200 and transmits the request to the name resolution unit 30.

The name resolution unit 30 determines an access NW to which the terminal 200 is connected, the closest edge platform 400 in a case where the terminal 200 is connected to the access NW among one or more edge platforms 400 on which the app for which name resolution is requested runs, and thus, information of the app which should be provided as a response. To determine these, the name resolution unit 30 refers to information which is stored in the storage unit 20 and which is necessary for making a response of an appropriate name resolution result when name resolution of the app which runs on the edge platform is requested. Then, the name resolution unit 30 creates a name resolution result on the basis of the determination and transmits the name resolution result to the name resolution result transmission unit 50.

Further, the name resolution unit 30 stores the name resolution result and a condition upon the name resolution (information regarding a terminal which performs the name resolution result, and an access NW to which the terminal is connected upon the name resolution result) together in the storage unit 20.

At the same time, the name resolution unit 30 transmits a notification indicating that a response of name resolution is made in response to the request for name resolution from the terminal 200, to the name resolution result control unit 40.

The name resolution result transmission unit 50 transmits the received name resolution result to the name resolution request/response unit 210 of the terminal 200. As a result of this, the terminal 200 starts connection to the app which runs on the edge platform 400 on the basis of the received name resolution result.

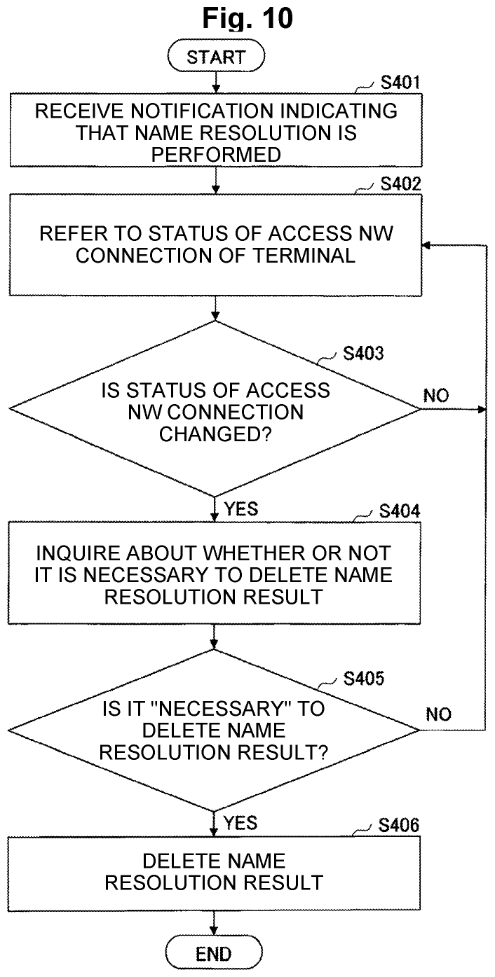

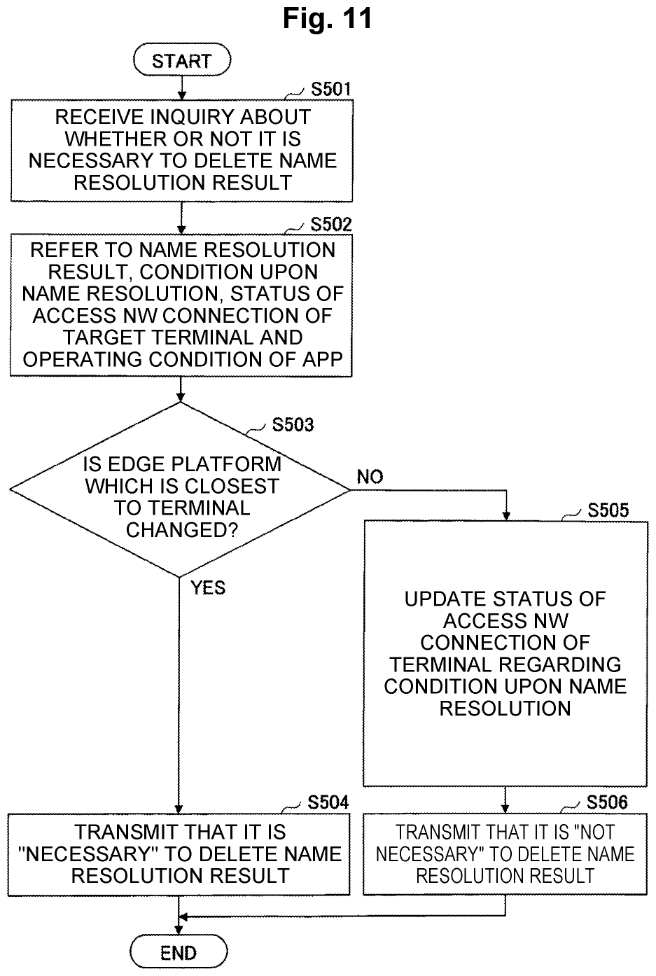

Subsequent operation relating to the name resolution result control unit 220 on the terminal 200 side and the name resolution result control unit 40 on the name resolution result control system 100 (edge management platform) side will be described with reference to FIG. 10 (terminal 200 side) and FIG. 11 (name resolution result control system 100 side).

<Operation of Name Resolution Result Control Unit 220 and Name Resolution Result Control Unit 40>

In S401 in FIG. 10, the name resolution result control unit 40 on the name resolution result control system 100 side transmits the notification indicating that name resolution is performed from the name resolution unit 30 to the name resolution result control unit 220 on the terminal 200 side, and the name resolution result control unit 220 receives the notification.

In S402 in FIG. 10, the name resolution result control unit 220 on the terminal 200 side starts continuous monitoring of a status of access NW connection of the terminal 200 to be stored in the storage unit 20 of the name resolution result control system 100 by being triggered by the notification indicating that name resolution is performed.

In S403, the name resolution result control unit 220 determines whether or not the access NW to which the terminal 200 is to be connected changes. In a case where a determination result in S403 is No, the processing returns to S402, and in a case where the determination result in S403 is Yes, the processing proceeds to S404.

In S404, that is, in a case where the access NW to which the terminal 200 is to be connected changes, the name resolution result control unit 220 on the terminal 200 side makes an inquiry to the name resolution result control unit 40 on the name resolution result control system 100 side as to whether or not it is necessary to delete the name resolution result.

In S501 in FIG. 11, the name resolution result control unit 40 receives the inquiry. In S502 in FIG. 11, the name resolution result control unit 40 refers to the information stored in the storage unit 20 (such as the name resolution result and the condition upon the name resolution, the status of access NW connection of the terminal for which the name resolution is performed, and the operating condition of the app on the edge platform).

In S503 in FIG. 11, the name resolution result control unit 40 determines whether the edge platform 400 which is the closest to the terminal 200 among one or more edge platforms on which the app for which name resolution is requested by the terminal 200 runs changes.

In a case where a determination result in S503 is Yes, that is, in a case where the edge platform 400 changes, the processing proceeds to S504, and the name resolution result control unit 40 transmits a response of “necessary” to delete the name resolution result to the name resolution result control unit 220 on the terminal 200 side.

In a case where the determination result in S503 is No, that is, in a case where the edge platform does not change, the processing proceeds to S505, and the name resolution result control unit 40 updates the condition upon name resolution stored in the storage unit 20 on the basis of the status of access NW connection of the terminal 200 at that moment. Here, the information to be updated is information regarding a condition where the name resolution result is performed, that is, information regarding an access NW to which the terminal is connected, included in information regarding which terminal is connected to which access NW.

In S506, the name resolution result control unit 40 transmits a response of “unnecessary” to delete the name resolution result to the name resolution result control unit 220 on the terminal 200 side.

In S405 in FIG. 10, the name resolution result control unit 220 on the terminal 200 side determines whether or not a response of “necessary” to delete the name resolution result is received from the name resolution result control unit 40. In a case where a determination result in S405 is Yes, the processing proceeds to S406.

In S406, that is, in a case where a response of “necessary” to delete the name resolution result is received from the name resolution result control unit 40, the name resolution result control unit 220 on the terminal 200 side deletes the name resolution result stored in the own terminal 200.

A specific deleting method is not limited to a particular method. For example, deleting methods include a method in which the cache of the name resolution result is cleared or invalidated on the basis of an instruction from the name resolution result control unit 220 by authority of the terminal 200 itself and a function of cache control which is provided in the OS or the like, as standard.

In a case where a determination result in S405 is No, that is, in a case where a response of “unnecessary” to delete the name resolution result is received, the processing returns to S402, and the terminal 200 continuously monitors the status of access NW connection of the own terminal 200. Criteria for detection of change of the status of access NW connection in a case where the terminal 200 continues monitoring are based on the access NW to which the terminal 200 is connected when an inquiry is made to the name resolution result control unit 40 as to whether or not it is necessary to delete the name resolution result. In other words, it is determined whether or not the access NW changes from the access NW to which the terminal 200 is connected upon inquiry as to whether or not it is necessary to delete the name resolution result.

### Fourth Embodiment

A fourth embodiment will be described next. The fourth embodiment can be applied to all of the first to the third embodiments. Portions different from the first to the third embodiments will be mainly described below.

In the fourth embodiment, the name resolution result stored on the terminal 200 side is controlled (deleted) by the app which runs on the edge platform 400 and the terminal 200 in coordination with each other.

In the fourth embodiment, when the terminal 200 utilizes a service to be provided on the edge platform 400, the terminal 200 requests name resolution to the name resolution result control system 100 (edge management platform). Note that the app which runs on the edge platform 400 is aimed at a user of the service which is to be provided on the edge platform 400 and is not released on the Internet side. Further, the name resolution result control system 100 (edge management platform) includes API which provides a status of access NW connection of the terminal 200, and the app which runs on the edge platform 400 can grasp the access NW to which the terminal 200 is connected by way of the API.

The app starts continuous monitoring of the status of access NW connection of the terminal 200 by being triggered by establishment of connection between the terminal 200 and the app which runs on the edge platform 400. In a case where the app detects that the terminal 200 is connected to a different access NW, the app puts a request for changing the app to be connected for communication to the terminal 200. When the terminal 200 detects the request for changing the app, the terminal 200 clears or invalidates the cache of the name resolution result stored in the terminal 200. Note that in the fourth embodiment, a system including the edge management platform 100 and the edge platform 400 may be the name resolution result control system 100. In this case, the name resolution result control unit 40 may include the above-described app which runs on the edge platform 400.

### Fifth Embodiment

A fifth embodiment will be described next. The fifth embodiment can be applied to all of the first to the third embodiments. Portions different from the first to the third embodiments will be mainly described below.

In the fifth embodiment, the name resolution result stored on the terminal 200 side is controlled (deleted) using the name resolution result in the response which is made by the name resolution result control system 100 (edge management platform) to the terminal 200.

In the fifth embodiment, when the name resolution result control system 100 (edge management platform) creates a name resolution result for the terminal 200, the name resolution result control system 100 embeds information of an access NW in which the name resolution result is valid, in the name resolution result.

A specific method of embedding the information of an access NW is not limited to a particular method. For example, the method includes a method in which information of an access NW in which the name resolution result is valid is embedded in an A record of a DNS.

Every time the access NW to which the terminal 200 is to be connected is changed or the change is detected, the cache of the name resolution result stored in the terminal 200 is referred to, and a cache other than the cache of the valid name resolution result is deleted each time. The cache of the name resolution result stored in the terminal 200 may be referred to and deleted by the name resolution result control system 100 (edge management platform) by way of the app on the terminal 200 as described in the second embodiment or may be referred to and deleted by the terminal 200 itself as described in the third embodiment.

### Sixth Embodiment

A sixth embodiment will be described next. The sixth embodiment can be applied to all of the first to the fifth embodiments. Portions different from the first to the fifth embodiments will be mainly described below. Further, functions of the sixth embodiment may be provided in addition to the functions of the first to the fifth embodiments.

While in the first to the fifth embodiments, control is performed for deleting the name resolution result stored in the terminal 200 by being triggered by change of the access NW to which the terminal 200 is to be connected, this deletion technique can also be applied to failover which is triggered by occurrence of a defect of the app which runs on the edge platform 400.

The name resolution result control unit 40 of the name resolution result control system 100 (edge management platform) grasps an operating condition of the app on the edge platform 400 on the basis of information in the storage unit 20. Thus, the name resolution result control unit 40 deletes the name resolution result held by the terminal 200 on the initiative of the name resolution result control system 100 (edge management platform) in a similar manner to the second embodiment by being triggered by occurrence of a defect of the app which is being utilized by the terminal 200.

However, in a case where the name resolution result control system 100 (edge management platform) includes API which provides the operating condition of the app on the edge platform 400, the terminal 200 which can grasp the operating condition of the app on the edge platform 400 by way of the API or the app on the edge platform 400 may delete the name resolution result held by the terminal 200. Note that in a case where the terminal 200 or the app on the edge platform 400 deletes the name resolution result held by the terminal 200, the name resolution result control unit 40 of the name resolution result control system 100 may include the terminal 200 or the app on the edge platform 400.

The terminal 200 requests name resolution again to utilize the service, and the name resolution result control system 100 (edge management platform) makes a response of an appropriate name resolution result upon occurrence of the request for name resolution. Thus, as a result, the terminal 200 can continuously utilize the service to be provided on the edge platform 400.

### Seventh Embodiment

A seventh embodiment will be described next. The seventh embodiment can be applied to all of the first to the fifth embodiments. Portions different from the first to the fifth embodiments will be mainly described below. Further, functions of the seventh embodiment may be provided in addition to the functions of the first to the sixth embodiments.

In the first to the fifth embodiments, control for deleting the name resolution result held by the terminal 200 is performed by being triggered by change of the access NW to which the terminal 200 is to be connected. The trigger is not limited to the above-described trigger, and this deletion technique can also be applied to a case where the app to which the terminal 200 is to be connected is changed by being triggered by completion of synchronization of databases and live migration between the terminal 200 and the edge platform 400 or between the edge platforms 400.

The name resolution result control unit 40 of the name resolution result control system 100 (edge management platform) in the seventh embodiment can grasp a status of implementation of synchronization of databases and live migration from the information collected in the storage unit 20. If the name resolution result control unit 40 detects completion of synchronization of databases and processing of live migration, the name resolution result held by the terminal 200 is deleted on the initiative of the name resolution result control system 100 (edge management platform) in a similar manner to the second embodiment.

However, the terminal 200 or the like, which grasps a status of synchronization of databases and live migration performed on the edge platform by way of the API or the like, may delete the name resolution result held by the terminal 200. Note that in a case where the terminal 200 deletes the name resolution result held by the terminal 200, the name resolution result control unit 40 of the name resolution result control system 100 may include the terminal 200.

This enables switching of a connection destination at a timing at which various kinds of processing such as transaction are completed on the edge platform 400. For example, even in a case where the closest edge platform 400 is changed by the terminal 200 moving across areas, a different edge platform can take over subsequent processing by the app on the edge platform by the app which runs on the edge platform 400 referring to a database which has been created from processing results.

(Hardware Configuration Example)

Both the name resolution result control system 100 and the terminal 200 can be implemented by, for example, causing a computer to execute programs. This computer may be a physical computer or may be virtual machine.

In other words, the device (the name resolution result control system 100 or the terminal 200) can be implemented by executing a program corresponding to processing to be performed by the device using hardware resources such as a CPU and a memory incorporated into the computer. The above-described program can be stored or distributed by being recorded in a computer-readable recording medium (such as a portable memory). Further, the above-described program can be provided through a network such as the Internet and e-mail.

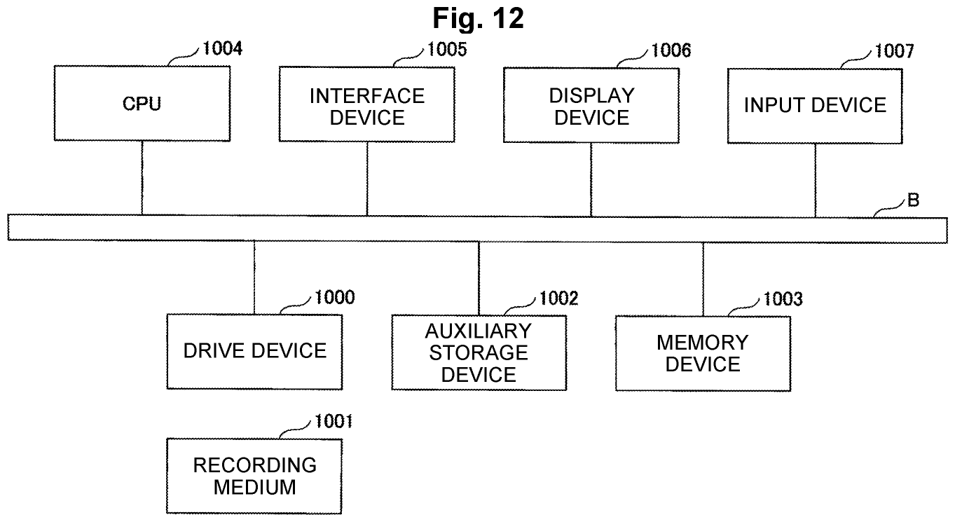

FIG. 12 is a view illustrating a hardware configuration example of the above-described computer. The computer in FIG. 12 includes a drive device 1000, an auxiliary storage device 1002, a memory device 1003, a CPU 1004, an interface device 1005, a display device 1006, an input device 1007, or the like, which are connected to one another with a bus B.

The program which implements the processing at the computer is provided by a recording medium 1001 such as, for example, a CD-ROM and a memory card. When the recording medium 1001 in which the program is stored is set in the drive device 1000, the program is installed in the auxiliary storage device 1002 from the recording medium 1001 via the drive device 1000. However, the program does not necessarily have to be installed from the recording medium 1001 and may be downloaded from other computers via a network. The auxiliary storage device 1002 stores the installed program and stores necessary files, data, and the like.

In a case where an instruction to start the program is issued, the memory device 1003 reads out the program from the auxiliary storage device 1002 and stores the program. The CPU 1004 implements functions relating to the device in accordance with the program stored in the memory device 1003. The interface device 1005 is used as interface for connecting to a network and functions as input means and output means via a network. The display device 1006 displays graphical user interface (GUI) or the like, by the program. An input device 157 is constituted by a keyboard, a mouse, a button, a touch panel, or the like, and is used to input various operation instructions.

(Effects of Embodiments)

As described above, according to the technique according to the embodiments, an appropriate name resolution response in which a geographical position of a terminal is taken into account can be made in response to a request for name resolution by a response of a name resolution result associated with NW information. Further, occurrence of a request for name resolution on the terminal side is controlled by control of the name resolution result stored on the terminal side associated with NW information, which allows the terminal to request name resolution only when it is truly necessary, so that it is possible to avoid nonoccurrence of a request for name resolution when it is necessary and avoid occurrence of an unnecessary request for name resolution.

(Conclusion of Embodiments)

The present specification discloses at least the name resolution result control system, the name resolution result control method and the program in the following items.

### (First Item)

A name resolution result control system which controls a name resolution result at a terminal which utilizes an application on one or more edge platforms which are physically deployed in a dispersed manner, the name resolution result control system including

a name resolution unit configured to receive a request for name resolution for the application from the terminal and transmit information of the application on an edge platform which is optimal for the terminal to the terminal as a name resolution result, and

a name resolution result control unit configured to execute control for deleting the name resolution result at the terminal by being triggered by a predetermined event.

### (Second Item)

The name resolution result control system according to the first item, in which the name resolution result control unit executes control for deleting the name resolution result at the terminal in a case where change of an edge platform on which the application runs and which is optimal for the terminal is detected as the predetermined event.

### (Third Item)

The name resolution result control system according to the second item, in which the name resolution result control unit deletes the name resolution result at the terminal or

the name resolution result control unit causes the terminal to delete the name resolution result by transmitting a response indicating that it is necessary to delete the name resolution result to the terminal in response to an inquiry from the terminal.

### (Fourth Item)

The name resolution result control system according to any one of the first to the third items, in which

the name resolution result control unit executes control for deleting the name resolution result at the terminal in a case where occurrence of a defect of the application is detected as the predetermined event.

### (Fifth Item)

The name resolution result control system according to any one of the first to the fourth items, in which

the name resolution result control unit executes control for deleting the name resolution result at the terminal in a case where completion of synchronization of databases or live migration between the terminal and an edge platform or between edge platforms is detected as the predetermined event.

### (Sixth Item)

A name resolution result control method to be executed by a name resolution result control system which controls a name resolution result at a terminal which utilizes an application on one or more edge platforms which are physically deployed in a dispersed manner, the name resolution result control method including

a name resolution step of receiving a request for name resolution for the application from the terminal and transmitting information of the application on an edge platform which is optimal for the terminal to the terminal as a name resolution result, and

a name resolution result control step of executing control for deleting the name resolution result at the terminal by being triggered by a predetermined event.

### (Seventh Item)

A program for causing a computer to function as the units in the name resolution result control system according to any one of the first to the fifth items.

While embodiments have been described above, the present invention is not limited to such specific embodiments, and various modifications and changes can be made within the scope of the gist of the present invention recited in the claims.

### REFERENCE SIGNS LIST

100 Name resolution result control system

10 Monitoring unit

20 Storage unit

30 Name resolution unit

40 Name resolution result control unit

50 Name resolution result transmission unit

60 Name resolution request reception unit

200 Terminal

210 Name resolution request/response unit

220 Name resolution result control unit

300 NW

400 Edge platform

1001 Recording medium

1002 Auxiliary storage device

1003 Memory device

1004 CPU

1005 Interface device

1006 Display device

1007 Input device

1. A name resolution result control system that controls a name resolution result at a terminal, which utilizes an application on one or more edge platforms that are physically deployed in a dispersed manner, the name resolution result control system comprising:
a name resolution unit, implemented with one or more processors, configured to receive a request for name resolution for the application from the terminal and transmit information of the application on the one or more edge platforms to the terminal as the name resolution result; and
a name resolution result control unit, implemented with one or more processors, configured to execute control for deleting the name resolution result at the terminal by being triggered by a predetermined event.

2. The name resolution result control system according to claim 1, wherein the name resolution result control unit executes control for deleting the name resolution result at the terminal in a case where change of the one or more edge platforms upon which the application runs and which is detected as the predetermined event.

3. The name resolution result control system according to claim 2, wherein the name resolution result control unit deletes the name resolution result at the terminal or causes the terminal to delete the name resolution result by transmitting a response indicating a necessity to delete the name resolution result to the terminal in response to an inquiry from the terminal.

4. The name resolution result control system according to claim 1, wherein the name resolution result control unit executes control for deleting the name resolution result at the terminal in a case where occurrence of a defect of the application is detected as the predetermined event.

5. The name resolution result control system according to claim 1, wherein the name resolution result control unit executes control for deleting the name resolution result at the terminal in a case where completion of synchronization of databases, or (ii) live migration between the terminal and the one or more edge platforms, platform or between the one or more edge platforms, is detected as the predetermined event.

6. A name resolution result control method to be executed by a name resolution result control system that controls a name resolution result at a terminal, which utilizes an application on one or more edge platforms that are physically deployed in a dispersed manner, the name resolution result control method comprising:
receiving a request for name resolution for the application from the terminal and transmitting information of the application on the one or more edge platforms to the terminal as the name resolution result; and
executing control for deleting the name resolution result at the terminal by being triggered by a predetermined event.

7. (canceled)

8. A non-transitory, computer-readable medium storing one or more instructions, that upon execution, cause a computer system to perform operations comprising:
in response to receiving a request for name resolution for an application on one or more edge platforms that are physically deployed in a dispersed manner, transmitting information of the application on the one or more edge platforms to a terminal as a name resolution result; and
executing control for deleting the name resolution result at the terminal by being triggered by a predetermined event.
